(19) United States
(12) Patent Application Publication
(10) Pub. No.: US 2009/0183214 A1
(43) Pub. Date: Jul. 16, 2009

(54) Apparatus and Method for Arranging and Playing a Multimedia Stream

(75) Inventors: Yang-Chih Shen, Taipei (TW); Chun-Ching Huang, Chiayi City (TW)

Correspondence Address: GROSSMAN, TUCKER, PERREAULT & PFLEGER, PLLC, 55 SOUTH COMMERICAL STREET, MANCHESTER, NH, 03101, US

(73) Assignee: SILICON MOTION, INC., Jhubei City (TW)

(21) Appl. No.: 11/972,673

(22) Filed: Jan. 11, 2008

(51) Int. Cl. H04N 7/173

(52) U.S. Cl. 725/105

(57) ABSTRACT

Apparatuses and methods for arranging and playing a multimedia stream are provided. The multimedia stream comprises both a video and audio stream. The apparatus is configured to write a first portion of the video stream and to write a first portion of the audio stream corresponding to the first portion of the video stream. After that, the processor writes a next portion of the video stream and writes a next portion of the audio stream corresponding to the next portion of the video stream into the file as well. The buffer is configured to temporarily store the first portion and the next portion of the audio streams before being written into the file. The arranged multimedia stream can be played by apparatus with limited resources.

### CROSS-REFERENCES TO RELATED APPLICATIONS

Not applicable.

### BACKGROUND OF THE INVENTION

1. Field of the Invention

The present invention relates to an apparatus and a method for arranging and playing a multimedia stream. More particularly, the present invention arranges a multimedia stream by interleaving its video stream and audio stream, and plays the arranged multimedia stream.

2. Descriptions of the Related Art

Due to the rapid development of communication and multimedia technologies, more and more multimedia files are created. Furthermore, people can watch multimedia streams not only on conventional computers but also on mobile devices. A multimedia stream usually comprises both a video stream and an audio stream. When a device plays (or accesses) the multimedia stream, the video and audio streams need to be synchronized for optimal performance.

FIG. 1 illustrates a file structure 11 for storing a multimedia stream in the prior art. The file structure 11 comprises a first part 111 with block 0 to block n and a second part 112 with block n+1 to block m. Each of the blocks may be a sector or a user-defined storage unit. The first part 111 stores a video stream of the multimedia stream, while the second part 112 stores an audio stream of the multimedia stream. The video and audio streams are stored separately in the file structure 11 because they are essentially different kinds of multimedia, which result in different encoding and decoding methods. Since the video and audio streams are stored separately, a device that intends to access both streams must have two accessing pointers, i.e. a video accessing pointer 121 and an audio accessing pointer 122.

The file structure 11 and corresponding accessing method have some drawbacks. The first drawback is the huge performance degradation. When a device plays the multimedia stream stored in the file structure like the one shown in FIG. 1, it needs the ability to randomly access the streams to synchronize both the video and audio streams. It is known that random accessing consumes a lot of resources of a device. If the device is mobile/portable with limited resources, it may not be able to play the multimedia file fluently. Even more, during the period of playing the multimedia file, the mobile/portable device may be unable to process other functions.

Another drawback is the need of a huge buffer in addition to an extra timer or counter to achieve the synchronization between the video and audio stream. There are two main approaches to synchronizing the video and audio streams. The first approach is to use two independent trigger mechanisms for the video and audio streams, wherein the trigger mechanisms depend on the system clock of the device. The trigger mechanism for the video stream triggers a portion of the video stream every predetermined time interval, while the trigger mechanism for the audio stream triggers a portion of the audio stream with its predetermined time interval. The second synchronization approach is to trigger a portion of the video stream every portion of the audio stream, wherein the portion of the audio stream comprises more than one audio sample. A more concrete example is given here with N indicating the video frame rate of the video stream and M indicating the audio sampling rate of the audio stream. The fact that N video frames and M audio samples exist in one second means that one video frame corresponds to MIN audio samples. One example is that a portion of the video stream is one video frame, while a portion of the audio stream comprises MIN audio samples. The second approach triggers one portion of the video stream (i.e. one video frame) every one portion of the audio stream (i.e. MIN audio samples). Before the trigger, both approaches have to completely decode the video and audio frames and store them in the buffer so that the device can play them smoothly.

According to the aforementioned descriptions, using the conventional file structure to store a multimedia stream has some drawbacks. The drawbacks become more evident when a device, with limited resources, intends to play a multimedia file. Consequently, a new structure for storing a multimedia file as well as a corresponding method for arranging the stored video and audio parts of the multimedia file are still in high demand.

### SUMMARY OF THE INVENTION

An objective of this invention is to provide a method for arranging a multimedia stream. The multimedia stream comprises a video stream and an audio stream. The method comprises the following steps: (a) writing a first portion of the video stream, (b) writing a first portion of the audio stream corresponding to the first portion of the video stream, (c) writing a next portion of the video stream after the step (a) and the step (b), and (d) writing a next portion of the audio stream corresponding to the next portion of the video stream after the step (a) and the step (b).

Another objective of this invention is to provide an apparatus for arranging a multimedia stream. The multimedia stream comprises a video stream and an audio stream. The apparatus comprises a processor. The processor is adapted to write a first portion of the video stream, to write a first portion of the audio stream corresponding to the first portion of the video stream, to write a next portion of the video stream after the writings of the first portion of the video stream and the first portion of the audio stream, and to write a next of the audio stream corresponding to the next portion of the video stream after the writings of the first portion of the video stream and the first portion of the audio stream.

A further objective of this invention is to provide a method for playing a multimedia stream. The multimedia stream comprises a first video portion, a next video portion, a first audio portion, and a next audio portion. The first video portion and the first audio portion come before the next video portion and the next audio portion. The method comprises the steps of: (a) decoding the first video portion to derive a first decoded video portion; (b) decoding the first audio portion to derive a first decoded audio portion; (c) playing the first decoded video portion and the first decode audio portion; (d) decoding the second video portion to derive a second decoded video portion after the step (a) and the step (b); (e) decoding the second audio portion to derive a second decoded audio portion after the step (a) and the step (b); and (f) playing the second decoded video portion and the second decode audio portion after the step (c).

Yet a further objective of this invention is to provide an apparatus of for playing a multimedia stream. The multimedia stream comprises a first video portion, a next video portion, a first audio portion, and a next audio portion. The first video portion and the first audio portion comes before the next video portion and the next audio portion. The apparatus comprises a processor. The processor is adapted to play the first video portion and the first audio portion and to play the next video portion and the next audio portion after the playings of the first video portion and the first audio portion. The apparatus may further comprise a buffer for temporarily storing the first audio portion and the next audio portion, wherein a size of the buffer being smaller than a size of the first video portion and a size of the next video portion.

For a multimedia stream comprising both a video stream and an audio stream, the present invention arranges portions of the video stream and portions of the audio stream under the rules that a previous portion of the video and audio streams comes before the next portion of the video and audio streams. That is, after arrangement the portions of the video and audio streams corresponding to a previous time interval come before the portions of the video and audio streams corresponding to a next time interval. The present invention arranges the multimedia stream according to this concept; therefore, a device intends to play the arranged multimedia stream can play it in this order without being equipped with a buffer, a counter or a timer. This means that the device can output a portion of the video stream and a portion of the audio frame right after decoding them, i.e. without buffering the decoded result or just buffering a small part of the decoded result. The characteristic is especially suitable for a portable device with limited resources.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 illustrates a file structure for storing a multimedia stream in the prior art;

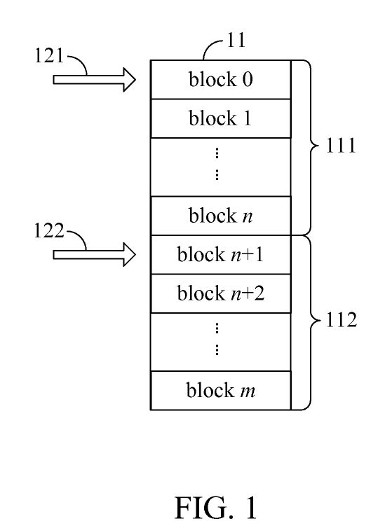

FIG. 2 illustrates a first embodiment of the present invention;

FIG. 3 illustrates a file structure of the file in the first embodiment;

FIG. 4 illustrates an example of the relation between the frame rate and sampling rate;

FIG. 5 illustrates a second embodiment of the present invention;

FIG. 6A illustrates a part of the flowchart of a third embodiment of the present invention;

FIG. 6B illustrates another part of the flowchart of the third embodiment; and

FIG. 7 illustrates a flowchart of a fourth embodiment of the present invention.

### DESCRIPTION OF THE PREFERRED EMBODIMENT

The objective of the present invention is to provide an apparatus and a method for arranging a multimedia stream into by interleaving a video stream and an audio stream of the multimedia stream. The corresponding apparatus and method for playing the arranged multimedia stream are provided as well.

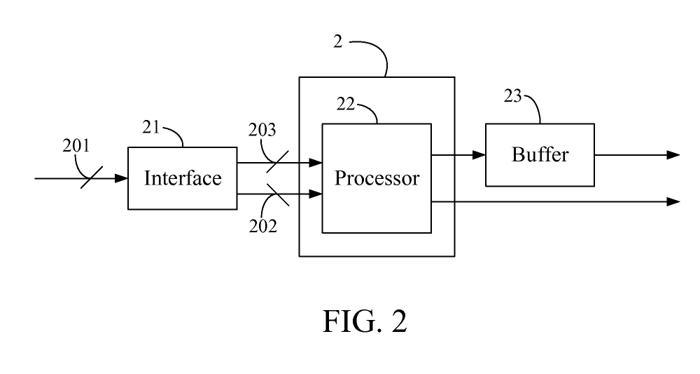

FIG. 2 illustrates a first embodiment of the present invention, which is an apparatus 2 for arranging a multimedia stream 201. The apparatus 2 comprises a processor 22 and operates in cooperation with an interface 21 and a buffer 23. In other embodiments, the interface 21 and the buffer 23 may be equipped within the apparatus 2.

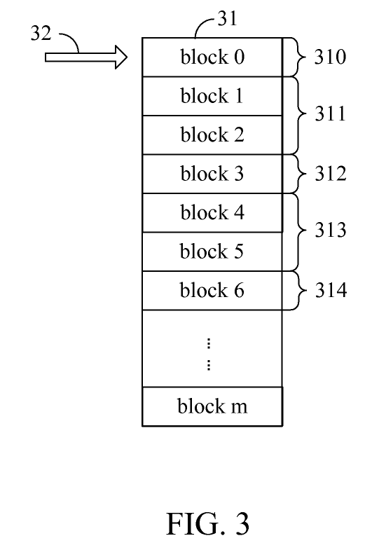

The interface 21 receives the multimedia stream 201, wherein the multimedia stream 201 comprises a video stream 202 and an audio stream 203. FIG. 3 illustrates a file structure 31 of the multimedia stream 201. After the interface 21 receives the multimedia stream 201, the processor 22 writes a header 310 of the multimedia stream 201 into the file, then writes a first portion 311 of the video stream 202 into the file, and then writes a first portion 312 of the audio stream 203 corresponding to the first portion 311 of the video stream into the file. After the first portion 311 of the video stream 202 and the first portion 312 of the audio stream 203 have been written into the file, the processor 22 writes a next portion 313 of the video stream 202 and a next portion 314 of the audio stream 203 corresponding to the next portion 313 of the video stream 202 into the file. The determinations of the first portions 311, 312 and the next portions 313, 314 will be explained later. If there are some portions of the video streams 202 and audio streams 203 that have not been written in, the processor 22 will continue to interleave them into the file. During the aforementioned process, the buffer 23 may temporarily store the first portion and the next portion of the audio streams before they are written into the file. It is noted that the processor 22 may write the aforementioned first portions 311, 312 and the next portions 313, 314 into another multimedia stream to be directly transmitted.

From the file structure 31 shown in FIG. 3, it is understood that the processor 22 writes the multimedia stream 201 into the file by interleaving the video stream 202 and audio stream 203. According to the file structure 31, the header may occupies block 0 of a storage storing the file, the first portion 311 of the video stream 202 may occupies blocks 1 and 2 of the storage storing the file, the first portion 312 of the audio stream 203 may occupies block 3 of the storage storing the file, the next portion 313 of the video stream 202 may occupies blocks 4 and 5 of the storage storing the file, and the next portion 314 of the audio stream 203 may occupies block 6 of the storage storing the file.

Before the processor 22 writes the multimedia stream 201 into the file, it decides a frame rate for the video stream 202 and a sampling rate for the audio stream 203. In this embodiment, it is assumed that the frame rate is N frames per second and the sampling rate is M samples per second. Then, the processor 22 encodes the video stream 202 into a plurality of video frames according to the frame rate N and encodes the audio stream 203 into a plurality of audio samples according to the sampling rate M. In some cases, a video stream and an audio stream of a multimedia steam may already be encoded into video frames and audio samples. In those cases, the processor 22 does not have to perform the deciding and encoding; the processor 22 only needs to determine the frame rate and sampling rate from the video stream and the audio stream.

The determinations of the first portions 311, 312 and next portions 313, 314 are explained in the following paragraphs. In this embodiment, each of the first portion 311 and next portion 313 of the video stream 202 comprises one of the video frames. Similarly, each of the first portion 312 and the next portion 314 of the audio stream 203 comprises a calculated number of audio samples. In other embodiments, both the first portion 311 and next portion 313 of the video stream 202 may each comprise only a part of one video frame, such as a slice, a macro-block, a macro-block row, etc, in which the first portion 312 and the next portion 314 of the audio stream 203 then comprise the corresponding parts.

The first portions 311, 312 and the next portions 313, 314 are determined according to the frame rate N and the sampling rate M. This embodiment is able to deal with various combinations of M and N and other requirements: (1) M being a multiple of N, (2) M being not a multiple of N, and (3) the number of audio samples with in an audio frame being fixed.

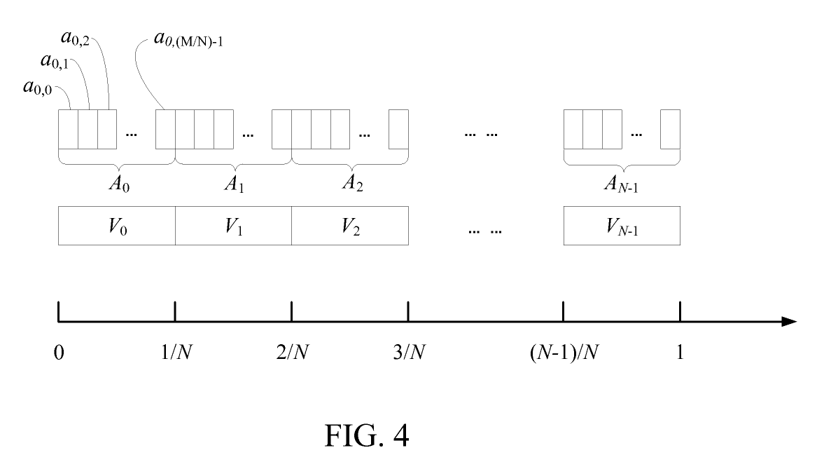

First, the determination of the first portions 311, 312 and the next portions 313, 314, when M is a multiple of N is described. The variables M and N indicate that there should be N video frames and M audio samples in one second. That is, there should be one frame and MIN audio samples every 1/N seconds as shown in FIG. 4. In FIG. 4, the horizontal axis represents time in units of seconds, every V₀, V₁, V₂, . . . , and V_{N-1} represents a video frame of the video stream, and every A₀, A₁, A₂, and A_{N-1} represents an audio frame of the audio stream. Furthermore, each of the Aᵢ comprises MIN audio samples. For example, the audio frame A₀ comprises audio samples a_{0,0}, a_{0,1}, . . . , and a_{0,M/N-1}. In this embodiment, the first portion 311 of the video stream 202 is determined to be the first video frame V₀, the first portion 312 of the audio stream 203 is determined to be the first audio frame A₀ (i.e. the first M/N audio samples a_{0,0}, a_{0,1}, . . . , and a_{0,M/N-1}), the next portion 313 of the video stream 202 is determined to be the next video frame V₁, and the next portion 314 of the audio stream 203 is determined to be the audio frame A₁, etc. According to these determinations, the first portion 311 of the video stream 202 and the first portion 312 of the audio stream 203 correspond to a first period of time (i.e. the first 1/N seconds). Similarly, the next portion 313 of the video stream 202 and the next portion 314 of the audio stream 203 correspond to a next period of time (i.e. the next 1/N seconds).

Here is a concrete example. Consider that the audio sampling rate is 44100 Hz (i.e. M=44100) and the frame rate is 15 frames per second (N=15), which calculates out to 44100 audio samples and 15 video frames within one second. That is, there are 44100/15=2940 audio samples and one video frame every 1/15 seconds. Consequently, this embodiment will write a video frame into the file, and then write an audio frame (i.e. 2940 audio samples) into the file and so on.

Second, the determination of the first portions 311, 312 and the next portions 313, 314, when M is not a multiple of N is described, that is, when MIN is not an integer. If MIN is not an integer, the audio frame comprises at least

$$⌊ \frac{M}{N} ⌋$$

audio sample. After the division, the residual audio samples are distributed into the audio frames. The first portion 311 of the video stream 202 is determined to be the first video frame, the first portion 312 of the audio stream 203 is determined to be the first audio frame, the next portion 313 of the video stream 202 is determined to be the next video frame, the next portion 314 of the audio stream 203 is determined to be the next audio frame, etc.

Lastly, the determination of the first portions 311, 312 and the next portions 313, 314 when the number of the audio samples within an audio frame should be fixed is described. An example is the MP3 format, which requires 1152 audio samples within one audio frame. Assume that the number of the audio samples required within an audio frame is L. The processor 22 first determines whether the number of the audio samples is a multiple of L. If it is not, the processor 22 pads several additional audio samples onto the audio samples until the resulting number of audio samples is a multiple of L. Then, the processor 22 determines the first portion 311 of the video stream 202 to be the first video frame. The processor 22 determines the first portion 312 of the audio stream 203 to comprise at least one audio frame, wherein a first temporal length corresponding to the audio samples comprised within the first portion 312 is great enough to cover the beginning boundary of another video frame. Then, the processor 22 determines the next portion 313 of the video stream 202 to be the next video frame. After that, the processor 22 determines the next portion 314 of the audio stream 203 to comprise at least one audio frame, wherein a second temporal length corresponding to the audio samples comprised within the next portion 314 is great enough to cover the beginning boundary of another video frame. To be more specific, the following rule is adopted by the processor 22:

$$If \{ [ ( \frac{M}{N} ) \times ( k + 1 ) ] \% L == 0 \} , then {\sum }_{i = 0}^{k} {A}_{i} = ( \frac{M}{N} ) \times ( k + 1 ) ;$$

$$else , {\sum }_{i = 0}^{k} {A}_{i} = \{ ⌊ \frac{( \frac{M}{N} ) \times ( k + 1 )}{L} ⌋ + 1 \} \times L ,$$

wherein k is the index of the audio frame, and

$${\sum }_{i = 0}^{k} {A}_{i}$$

denotes the accumulated number of audio samples from 0^{th} to k^{th} audio frame.

Here is a concrete example for the situation that the length of each audio frame is fixed, wherein M=44100, N=15, and L=1152. Since M/N=2940, a video frame should ideally appear every 2940 audio samples. That is, a video frame should appear every 2940 sampling ticks of the system 2. The sequence of the video frames and audio frames determined by the processor 22 is tabulated in Table 1 for convenience. According to the aforementioned rule, the processor 22 determines the first portion 311 of the video stream 202 to be the first video frame V₀. The processor 22 determines the first portion 312 of the audio stream 203 to be the three audio frames A₀, A₁, and A₂, wherein each audio frame has 1152 audio samples. After the audio frame A₂, the first temporal length corresponding to the written audio samples, i.e. first portion 312, is great enough to cover the beginning boundary of another video frame, that is, the sampling ticks of the first portion 312 (i.e. 1152×3=3456) is great enough to cover the beginning boundary of the next video frame V₁, which appears at the 2940^{th} sampling tick. Then, the processor 22 determines the next portion 313 of the video stream 202 to be the next video frame V₁. After that, the processor 22 determines the next portion 314 of the audio stream 203 to be the three audio frames A₃, A₄, and A₅. Similarly, after the audio frame A₂, the second temporal length (3456+1152×3=6912) corresponding to the written audio samples (i.e. the first portion 312 and the next portion 314) is great enough to cover the beginning of another video frame, which appears at the 5880^{th} sampling tick. Next, a next portion of the video stream 202 is determined to be the next video frame V₁. This time, the processor determines the next portion of the audio stream 203 to be the two audio frames A₆ and A₇. This is because a third temporal length (3456+3456+1152×2=9216) is great enough to cover the beginning of another video frame, which appears at the 8820^{th} sampling tick. The remainder of the multimedia stream is processed in the same way.

TABLE 1

| | Index | | | | | | | | | | | | |
|---|---|---|---|---|---|---|---|---|---|---|---|---|---|
| | 0 | 1 | 2 | 3 | 4 | 5 | 6 | 7 | 8 | 9 | 10 | 11 | . . . |
| frame | V₀ | A₀ | A₁ | A₂ | V₁ | A₃ | A₄ | A₅ | V₂ | A₆ | A₇ | V₃ | . . . |
| Sample | 0 | 0~1151 | 1152~2303 | 2304~3455 | 2940 | 3456~4607 | 4608~5759 | 5760~6911 | 5880 | 6912~8063 | 8064~9215 | 8820 | . . . |
| tick | | | | | | | | | | | | | |

The determinations of the first portions 311, 312, the next portions 313, 314, and so on for the three situations (based on M, N, and the required length of an audio frame) have been addressed. During the process of writing the multimedia stream 201 into the file, the processor 22 actually writes the audio samples one by one into the file according to the temporal order of the audio samples. To be more specific, the processor 22 writes the first portion 311 of the video stream 202 into the file. Then, the processor 22 writes the unwritten audio samples one by one into the file, calculates an accumulated number of the written audio samples, and repeats the writing of the unwritten audio samples and the calculating of the accumulated number until the accumulated number is equal to a first required number and a first temporal length corresponding to the written audio samples is greater than or is equal to a first required temporal length. By doing so, the first portion 312 of the audio stream 203 is written into the file. Then, the processor 22 writes the next portion 313 of the video stream 202 into the file. Following, the processor 22 writes the unwritten audio samples one by one into the file, calculates the accumulated number of the written audio samples, and repeats the writing of unwritten audio samples and the calculating of the accumulated number until both the accumulated number is equal to a second required number and a second temporal length corresponding to the written audio samples is greater than or is equal to a second required temporal length. Depending on the M, N, and L, the first required number, the second required number, the first temporal length, and the second temporal length are different.

Furthermore, after writing the first portions 311, 313 and the second portions 312, 314, the processor 22 will repeatedly write a next video frame and an audio frame until the whole multimedia stream has been arranged.

In some other cases, the apparatus 2 may write the first portion of the audio stream before the first portion of the video stream or write the next portion of the audio stream before the next portion of the video stream. The only requirement of the apparatus 2 is to interleave the video stream and the audio stream from time to time. Since the video stream and the audio stream are interleaved, only one accessing pointer, i.e. an audio/video pointer, is needed when a device intends to play the multimedia stream.

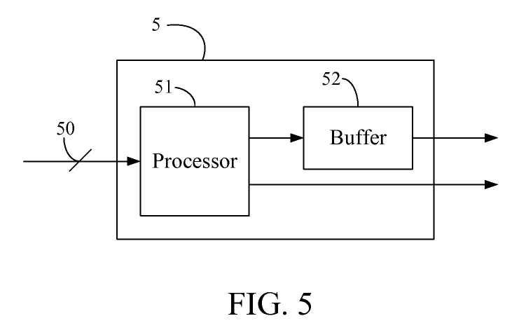

FIG. 5 illustrates a second embodiment of the present invention, which is an apparatus 5 of for playing a multimedia stream 50. The multimedia stream 50 has been arranged by the apparatus 2 in the first embodiment. To be more specific, the multimedia stream 50 comprises a first video portion, a next video portion, a first audio portion, and a next audio portion, wherein the first video portion and the first audio portion come before the next video portion and the next audio portion in the multimedia stream 50. Each of the first portion and the next portion of the video stream is one of an encoded micro-block, an encoded macro-block, an encoded macro-block row, an encoded slice, and an encoded frame. Each of the first audio portion and the next audio portion comprises a plurality of encoded audio samples.

The apparatus 5 comprises a processor 51 and a buffer 52, wherein a size of the buffer is smaller than a size of the first video portion and a size of the next video portion. The processor 51 decodes the first video portion to derive a first decoded video portion, decodes the first audio portion to derive a first decoded audio portion, and plays the first decoded video portion and the first decode audio portion. After that, the processor 51 decodes the second video portion to derive a second decoded video portion, decodes the second audio portion to derive a second decoded audio portion, and plays the second decoded video portion and the second decode audio portion.

When the first decoded video portion is being decoded, the buffer is used to temporarily store part of the first decoded audio portion. To be more specific, the first audio portion comprises several encoded audio samples, while the first video portion comprises one encoded video frame. When one of the audio samples (part of the first audio portion) has been decoded as an audio sample, the video frame has not been decoded yet. Therefore, the decoded audio samples can be stored in the buffer. Similarly, when the second decoded video portion is played, the buffer is used to temporarily store the second decoded audio portion.

The apparatus 5 may repeatedly decode and play the multimedia stream until the whole multimedia stream has decoded and played.

By the arrangement of the first and the second embodiments, multimedia streams can be arranged according to the temporal order and the arranged multimedia streams can be played by apparatuses with limited resources.

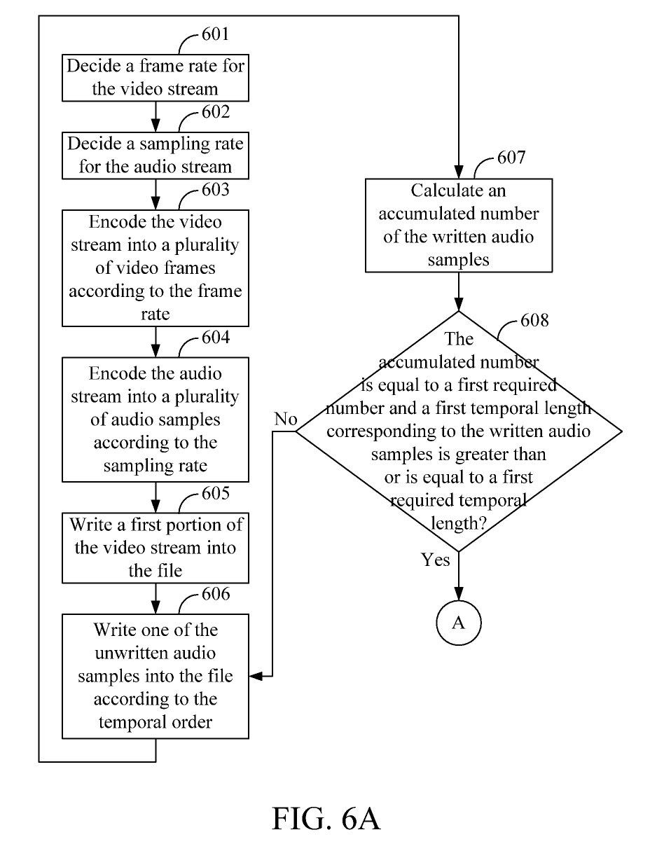

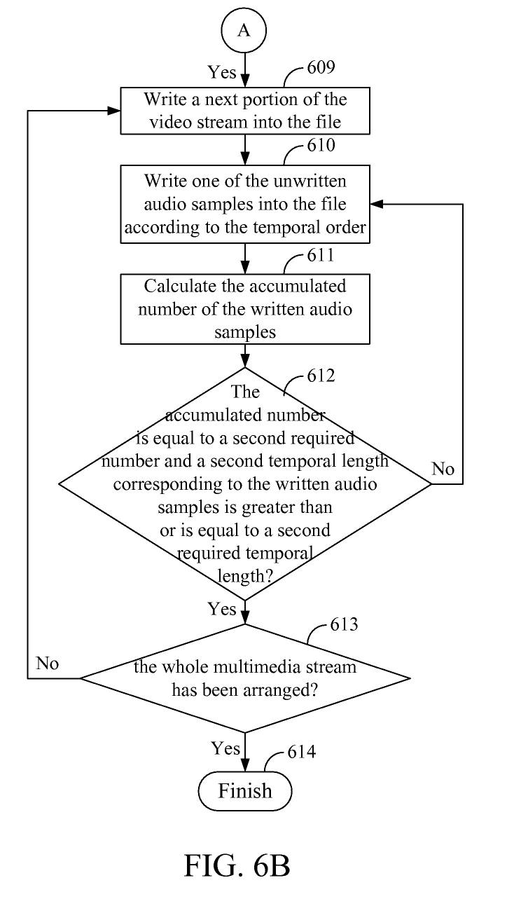

FIGS. 6A and 6B illustrate a flowchart of a third embodiment of the present invention. The multimedia stream comprises both a video stream and an audio stream. First, the method executes step 601 to decide a frame rate for the video stream. Then, the method executes step 602 to decide a sampling rate for the audio stream.

After the frame rate and the sampling rate have been decided, the method executes step 603 and step 604 to respectively encode the video stream into a plurality of video frames according to the frame rate and to encode the audio stream into a plurality of audio samples according to the sampling rate. Then, the method executes step 605 to write a first portion of the video stream into the file. After, the method executes step 606, 607, 608 to write a first portion of the audio stream corresponding to the first portion of the video stream into the file. To be more specific, step 606 writes one of the unwritten audio samples into the file according to the temporal order, while step 607 calculates the accumulated number of the written audio samples. Step 608 determines whether the accumulated number is equal to a first required number and whether a first temporal length corresponding to the written audio samples is greater than or equal to a first required temporal length. If not, then the method returns to step 606. If so, the method goes to step 609 to write a next portion of the video stream. Next, the method executes step 610, 611, 612 to write a next portion of the audio stream corresponding to the next portion of the video stream into the file. To be more specific, step 610 writes one of the unwritten audio samples into the file according to the temporal order, while step 611 calculates the accumulated number of the written audio samples. Step 612 determines whether the accumulated number is equal to a second required number and whether a second temporal length corresponding to the written audio samples is greater than or equal to a second required temporal length. If it is not, the method returns to step 610. If so, the method continues to step 613 to determine whether the whole multimedia stream has been arranged. If not, step 609 is returned. If so, step 614 is executed to finish the whole process.

Besides the aforementioned steps, this embodiment can further execute operations and methods described in the first embodiment.

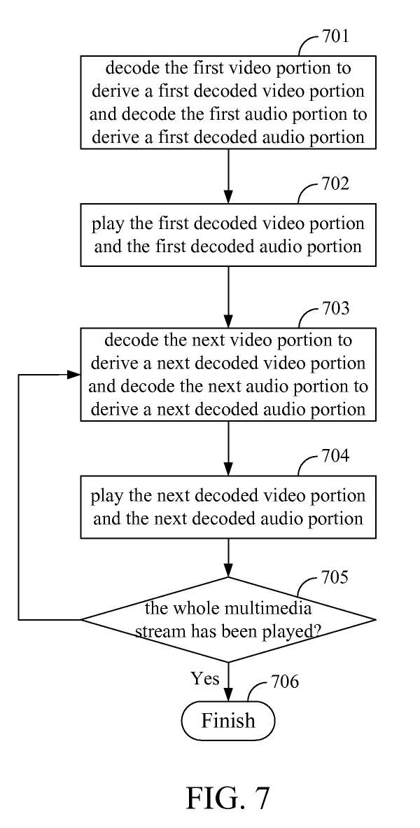

FIG. 7 illustrates a flowchart of fourth embodiment of the present invention, which is a method for playing a multimedia stream. The multimedia stream comprises a first video portion, a next video portion, a first audio portion, and a next audio portion. The first video portion and the first audio portion come before the next video portion and the next audio portion in the multimedia stream.

First, step 701 is executed to decode the first video portion to derive a first decoded video portion and to decode the first audio portion to derive a first decoded audio portion. After step 701 and step 702 is executed to play the first decoded video portion and the first decoded audio portion. Next, step 703 is executed to decode the next video portion to derive a next decoded video portion and to decode the second audio portion to derive a second decoded audio portion. After that, step 704 is executed to play the next decoded video portion and the next decoded audio portion. Then, step 705 is executed to determine whether the whole multimedia stream has been played. If not, step 703 is executed again. If so, step 706 is executed to finish the method.

Besides the aforementioned steps, this embodiment can further execute operations and methods described in the second embodiment.

The aforementioned method can be implemented by a computer program. In other words, any laptop, base station, and gateway can individually install the appropriate computer program which has codes to execute the aforementioned methods. The computer program can be stored in a computer readable medium. The computer readable medium can be a floppy disk, a hard disk, an optical disc, a flash disk, a tape, a database accessible from a network or a storage medium with the same functionality that can be easily thought by people skilled in the art.

According to the aforementioned description, the present invention interleaves the video stream and the audio stream of the multimedia stream in certain orders. Any device that intends to play the multimedia stream will decode and play the multimedia stream in the same order. For example, the present invention interleaves MIN audio samples with one video frame from time to time. Then, the device should decode and play the MIN audio samples one at video frame at a time. In other words, the device cannot decode the next video frame before the corresponding audio samples are decoded. This approach ensures that the audio stream and the video stream will be played in the order of the stream without an extra synchronization mechanism. Furthermore, a device can output the video frame and audio frame right after decoding. That is, the device does not need to buffer the decoded result of the whole video frame, which is especially suitable for a portable device with limited resources.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A method for arranging a multimedia stream, the multimedia stream of which including a video stream and an audio stream, the method comprising the steps of:
(a) writing a first portion of the video stream;
(b) writing a first portion of the audio stream corresponding to the first portion of the video stream;
(c) writing a next portion of the video stream after the step (a) and the step (b); and
(d) writing a next portion of the audio stream corresponding to the next portion of the video stream after the step (a) and the step (b).

2. The method of claim 1, further comprising the step of:
repeating the step (c) and step (d) until the whole multimedia stream has been arranged.

3. The method of claim 1, wherein the audio stream comprises a plurality of audio samples, the audio samples have a temporal order, and the step (b) comprises the steps of:
(b1) writing one of the unwritten audio samples according to the temporal order;
(b2) calculating an accumulated number of the written audio samples; and
(b3) repeating the step (b1) and the step (b2) in sequence until the accumulated number is equal to a first required number and a first temporal length corresponding to the written audio samples is greater than or is equal to a first required temporal length.

4. The method of claim 3, wherein the step (d) comprises the steps of:
(d1) writing one of the unwritten audio samples according to the temporal order;
(d2) calculating the accumulated number of the written audio samples; and
(d3) repeating step (d1) and step (d2) in sequence until the accumulated number is equal to a second required number and a second temporal length corresponding to the written audio samples is greater than or is equal to a second required temporal length.

5. The method of claim 1, further comprising the steps of:
deciding a frame rate for the video stream;
deciding a sampling rate for the audio stream;
encoding the video stream into a plurality of video frames according to the frame rate; and
encoding the audio stream into a plurality of audio samples according to the sampling rate,
wherein each of the first portion and the next portion of the video stream comprises one of the video frames and each of the first portion and the next portion of the audio stream comprises a calculated number of the audio samples.

6. The method of claim 5, wherein the first portion and the next portion of the audio stream are determined according to the frame rate and the sampling rate.

7. The method of claim 1, wherein the first portion of the video stream and the first portion of the audio stream correspond to a first period of time, and the next portion of the video stream and the next portion of the audio stream correspond to a next period of time.

8. The method of claim 1, further comprising a step of writing a header of the multimedia stream before step (a).

9. The method of claim 1, wherein each of the first portion and the next portion of the video stream is one of a micro-block, a macro-block, a macro-block row, a slice, and a frame.

10. An apparatus for arranging a multimedia stream, the multimedia stream of which comprising a video stream and an audio stream, the apparatus comprising:
a processor is adapted to write a first portion of the video stream, to write a first portion of the audio stream corresponding to the first portion of the video stream, to write a next portion of the video stream after the writings of the first portion of the video stream and the first portion of the audio stream, and to write a next portion of the audio stream corresponding to the next portion of the video stream after the writings of the first portion of the video stream and the first portion of the audio stream.

11. The apparatus of claim 9, wherein the audio stream comprises a plurality of audio samples, the audio samples have a temporal order, and the processor writes the first portion of the audio stream by writing one of the unwritten audio samples according to the temporal order, calculating an accumulated number of the written audio samples, and repeating the writing of unwritten audio samples and the calculating until the accumulated number is equal to a first required number and a first temporal length corresponding to the written audio samples is greater than or is equal to a first required temporal length.

12. The apparatus of claim 10, wherein the processor is adapted to write the next portion of the audio stream by writing one of the unwritten audio samples according to the temporal order, calculating the accumulated number of the written audio samples, and repeating the writing of unwritten audio samples and the calculating until the accumulated number is equal to a second required number and a second temporal length corresponding to the written audio samples is greater than or is equal to a second required temporal length.

13. The apparatus of claim 9, wherein the processor is further adapted to decide a frame rate for the video stream, decide a sampling rate for the audio stream, encode the video stream into a plurality of video frames according to the frame rate, and encode the audio stream into a plurality of audio samples according to the sampling rate, wherein each of the first portion and the next portion of the video stream comprises one of the video frames and each of the first portion and the next portion of the audio stream comprises a calculated number of the audio samples.

14. The apparatus of claim 12, wherein the first portion and the next portion of the audio stream are determined according to the frame rate and the sampling rate.

15. The apparatus of claim 9, wherein the first portion of the video stream and the first portion of the audio stream correspond to a first period of time, and the next portion of the video stream and the next portion of the audio stream correspond to a next period of time.

16. The apparatus of claim 9, wherein the processor further writes a header of the multimedia stream before writing the first portion of the video stream.

17. The apparatus of claim 9, wherein the processor repeats to write a next portion of the video stream and a corresponding portion of the audio stream after the writings of the previous portion of the video stream and the previous portion of the audio stream.

18. The apparatus of claim 9, wherein each of the first portion and the next portion of the video stream is one of a micro-block, a macro-block, a macro-block row, a slice, and a frame.

19. A method for playing a multimedia stream, the multimedia stream of which comprising a first video portion, a next video portion, a first audio portion, and a next audio portion, the first video portion and the first audio portion coming before the next video portion and the next audio portion in the multimedia stream, the method comprising the steps of:
(a) decoding the first video portion to derive a first decoded video portion;
(b) decoding the first audio portion to derive a first decoded audio portion;
(c) playing the first decoded video portion and the first decoded audio portion;
(d) decoding the next video portion to derive a next decoded video portion after the step
(a) and the step (b);
(e) decoding the next audio portion to derive a next decoded audio portion after the step
(a) and the step (b); and
(f) playing the next decoded video portion and the next decoded audio portion after the step (c).

20. The method of claim 19, wherein each of the first portion and the next portion of the video stream is one of a micro-block, a macro-block, a macro-block row, a slice, and a frame.

21. An apparatus of for playing a multimedia stream, the multimedia stream of which comprising a first video portion, a next video portion, a first audio portion, and a next audio portion, the first video portion and the first audio portion coming before the next video portion and the next audio portion in the multimedia stream, the apparatus comprising:
a processor is adapted to decode the first video portion to derive a first decoded video portion, to decode the first audio portion to derive a first decoded audio portion, to playing the first decoded video portion and the first decode audio portion, to decode the next video portion to derive a next decoded video portion after decoding the first video portion and the first audio portion, to decode the next audio portion to derive a next decoded audio portion after decoding the first video portion and the first audio portion, and to play the next decoded video portion and the next decode audio portion after playing the first decoded video portion and the first decode audio portion.

22. The apparatus of claim 21, further comprising:
a buffer for temporarily storing the first decoded audio portion and the next decoded audio portion, a size of the buffer being smaller than a size of the first video portion and a size of the next video portion.

23. The apparatus of claim 21, wherein each of the first portion and the next portion of the video stream is one of a micro-block, a macro-block, a macro-block row, a slice, and a frame.
